(19) United States
(12) Patent Application Publication
(10) Pub. No.: US 2009/0113213 A1
(43) Pub. Date: Apr. 30, 2009

(54) SYSTEM AND METHOD FOR SEARCHING ENCRYPTED NUMERICAL DATA

(76) Inventors: Taejun PARK, Seoul (KR); Dowon HONG, Daejeon-city (KR); Hyunsook CHO, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/251,511

(22) Filed: Oct. 15, 2008

(30) Foreign Application Priority Data
Oct. 24, 2007 (KR) 10-2007-0107106

(51) Int. Cl. G06F 21/24; H04L 9/06; G06F 7/06; G06F 17/30

(52) U.S. Cl. 713/189; 380/44; 707/2; 707/6; 707/E17.017

(57) ABSTRACT

A system for searching encrypted numerical data according to an embodiment of the present invention includes: a key generator that generates a key for encryption; an index generator that generates an index for documents from a plurality of documents including numerical data and the generated key, on the basis of individual digits of the numerical data and the positions of the digits; a trapdoor generator that generates a trapdoor including search information on the individual digits of the numerical data and the positions of the digits, using the generated key; and a document searching unit that receives numerical data for search, searches the index using the trapdoor, and outputs document information including the numerical data for search.

### RELATED APPLICATIONS

The present application claims priority to Korean Patent Application Serial Number 10-2007-0107106, filed on Oct. 24, 2007, the entirety of which is hereby incorporated by reference.

### BACKGROUND OF THE INVENTION

1. Field of the Invention

The present invention relates to a system and method for searching encrypted numerical data. In particular, the present invention relates to a system and method for searching encrypted numerical data which support wildcard searching and range searching.

This work was supported by the IT R&D program of MIC/IITA. [2005-Y-001-03, Developments of Next Generation Security Technology]

2. Description of the Related Art

In general, when a large amount of important documents are encrypted and stored in order to protect confidential information and privacy of users, various complex problems occur in searching specific contents existing in those documents. In particular, when the existing encryption method is applied to a specific keyword existing in a document, search is impossible.

In general, the current system uses an access control method that allows only authorized persons to access a server that stores important information in order to protect user information. However, this method is not prepared if security is breached by the server manager intentionally, that is, an insider. Because insiders already have access, they can easily access stored data.

If the stored data is unencrypted plaintext, it is possible to easily leak data to the outside and/or use the data.

In order to solve this problem, methods of encrypting documents and storing the encrypted documents have been developed. However, when the documents are encrypted, searching is impossible. As a result, it is necessary to perform encryption in respects to the search. An encryption method making searching possible is referred to as searchable encryption and has been developed in two different methods. The first uses a public key and can be used for email servers. The implementation of the first method uses an ID-based encryption and, for example, Tate pairing or Weil pairing using an elliptical curve is used as a primitive. However, this primitive is not an efficient operation and thus the first method is limited from a practical application standpoint. The second method uses a private key. A block code or a hash function is used of as the primitive of the private key, and the speed is very high. However, if an update is needed, all data related to the documents should be changed.

In a related technique, in order to search for encrypted documents stored in, for example, an email server, a transmitter uses a receiver's ID as a public key and combines a public key with a trapdoor suitable for a keyword and transmits it. In this way, a mail server cannot recognize which word a receiver uses for searching and thus it is possible to protect private email information. However, in the invention, a method of using a public key is used and is applied when a transmitter and a receiver differ from each other.

In another related technique, when documents are stored in an unreliable server, in order to encrypt and search for the documents, an XOR operation is performed on pseudorandom values using a stream code so as to generate a cryptogram and a search is performed using a private key. According to this technique, it is possible to efficiently search encrypted data using a private key. However, this technique is prone to statistical attacks and search time becomes longer according to the size of a document set.

Further, a method of performing a search after generating a trapdoor and an index for encrypted documents by using a private key has been disclosed. According to this method, it is possible to efficiently search for encrypted data.

However, in this technique, a more efficient searching method, for example, a method of performing a wildcard search or a range search on numerical data has not been implemented. Therefore, the application of the technique is limited in searching encrypted data.

### SUMMARY OF THE INVENTION

Accordingly, it is an object of the present invention to provide a method of searching encrypted data which makes it possible to perform a wildcard search and a range search for numerical data when searching encrypted data, in particular, numerical data.

According to an aspect of the present invention, there is provided a system for searching encrypted numerical data. The system includes: a key generator that generates a key for encryption; an index generator that generates an index for documents from a plurality of documents including numerical data and the generated key, on the basis of individual digits of the numerical data and the positions of the digits; a trapdoor generator that generates a trapdoor including search information on the individual digits of the numerical data and the positions of the digits, using the generated key; and a document searching unit that receives numerical data for search, searches the index using the trapdoor, and outputs document information including the numerical data for search.

The numerical data for search may include digits and the positions of the digits, and the document searching unit may search the index on the basis of the digits and the positions of the digits.

The numerical data for search may have range search or wildcard search conditions.

The document searching unit may search the index on the basis of the individual digits of the numerical data for search and the positions of the individual digits, and combine the search results to perform the range search or the wildcard search.

The index generator may express the numerical data included in the plurality of documents in a notation system of base n (n is a natural number equal to or greater than 2) and generates the index.

According to another aspect of the invention, there is provided a method of searching encrypted numerical data. The method includes: generating a key for encryption; generating an index for documents from a plurality of documents including numerical data and the generated key on the basis of individual digits of the numerical data and the positions of the digits; generating a trapdoor including search information on the individual digits of the numerical data and the positions of the digits, using the generated key; and receiving numerical data for search, searching for the index using the trapdoor, and outputting documents including the numerical data for search.

The numerical data for search may include digits and the positions of the digits, and in the searching of the documents, the index may be searched on the basis of the digits and the positions of the digits.

When numerical data having range search or wildcard search conditions is input as the numerical data for search, in the searching of the documents, searching may be performed on the basis of the individual digits, except for a wildcard, of the numerical data for search and the positions of the individual digits, and the search results may be combined to perform a wildcard search or a range search.

In the generating of the index, the numerical data included in the plurality of documents may be expressed in a notation system of base n (n is a natural number equal to or greater than 2) and the index is generated.

### BRIEF DESCRIPTION OF THE DRAWINGS

FIG. 1 is a diagram illustrating the configuration and operation of a system for searching encrypted numerical data according to an embodiment of the present invention; and

FIG. 2 is a diagram illustrating an example of a process of implementing a wildcard search in a method of searching encrypted numerical data according to another embodiment of the present invention.

### DESCRIPTION OF THE PREFERRED EMBODIMENTS

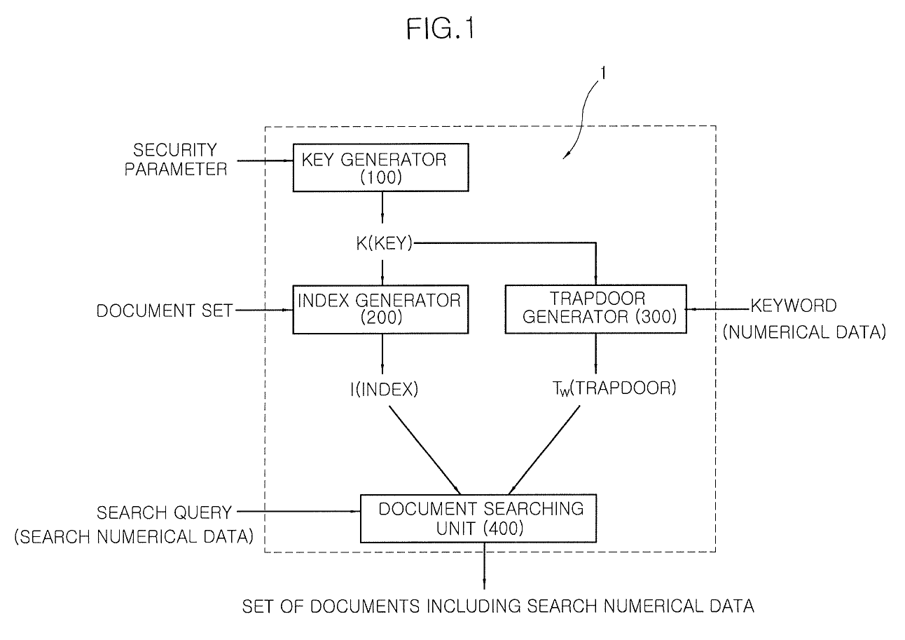

A system 1 for searching encrypted numerical data according to an embodiment of the invention will be described with reference to FIG. 1.

First, concepts and terms needed to explain the present invention will be described.

A radix expression is the most common numeral notation for computer arithmetic. The radix expression is performed using a base β and a digit set Σ={0, 1, . . . , β−1}. The radix expression of a number z is (dₙdₙ₋₁ . . . d₀)_{β} which means z=dₙβ″+dₙ₋₁βⁿ⁻¹+ . . . +d₀, where all dᵢεΣ. For example, if β is 3, the digit set is Σ={0,1,2} which is expressed as 16=(121)₃.

It is assumed that 2^{Σ} represents all possible documents having numerical data and N(≦2^{Σ}) represents a set of m documents having numerical data. In this case, N can be expressed as {N₀, N₁, . . . , Nₘ}. id(N) serves as an identifier of a document N having numerical data and is a string representing, for example, a memory location, which identifies a document. N(d⁽ⁱ⁾) is a list of identifiers of documents which include a digit d in the i-th position and are sorted in lexicographic order. N(d⁽ⁱ⁾) is regarded as the search result regarding d⁽ⁱ⁾.

A method of generating a private key and a cryptogram according to an embodiment of the present invention will be described. It is assumed that θ and l are security parameters and (G, E, D) is a semantically safe symmetric key cipher scheme. G receives the security parameter θ and generates a private key K. E receives the key K and an r-bit message M and generates a cryptogram C. Here, a function E:{0,1}^{l}×{0,1}^{r}→{0,1}^{r} can be considered. D uses the key K and the cryptogram C to restore plaintext M.

The system 1 for searching encrypted numerical data according to an embodiment of the present invention includes the following components: a key generator 100, an index generator 200, a trapdoor generator 300, and a document searching unit 400.

The key generator 100, using a stochastic key generating algorithm, is operated by a user, and sets up a scheme. The key generator 100 receives the security parameter and generates the private key K. Here, the length of the private key K is determined on the basis of the security parameter.

The index generator 200 is operated by the user and generates an index. The index generator 200 receives the private key K and a document set N and outputs an index I.

The trapdoor generator 300 receives a keyword w and generates a trapdoor T_{w} from the keyword w and the private key K.

The document searching unit 400 is operated by a server and searches for documents having the keyword w. The document searching unit 400 receives the index I and the trapdoor T_{w} and outputs a set of documents having the keyword w, which is referred to as a document set N( ).

Hereinafter, the operation of each of the above-mentioned components for searching encrypted numerical data will be described.

First, the key generator 100 generates a random key

$$x , y , z {←}^{R} {\{ 0 , 1 \}}^{θ}$$

and then generates a private key K=(x,y,z,1^{l}). The private key K is used for encryption and decryption by the following other components.

Next, the operation of the index generator 200 will be described.

In the index generator 200, the following initialization processes are performed.

(1) A base β is selected and a digit set Σ is set. The base and/or digit set may be determined by the user or the system may select an optimal base.

(2) Numerical data of each document is converted into a radix expression by using the base β and the digit set Σ. In the radix expression, the digits in individual positions are expressed as d and the positions corresponding to the individual digits are expressed as a variable i.

(3) N(d⁽ⁱ⁾) is generated with respect to all of d and i. N(d⁽ⁱ⁾) means a set of documents in which the digit in the i-th position of numerical data expressed in a radix notation using the base β is d.

(4) A global counter ctrl is initialized to 1.

Next, the index generator 200 generates an array A.

With respect to the array A, an element of an address value i is denoted by A[i]. The address value of an element x in the array A is denoted by addr(A(x)). In other words, if A[i]=x, addr(A(x))=i. A list L stored in the array A is a set of nodes Vᵢ= [symbol] νᵢ:addr(A(νᵢ₊₁) [symbol] .

The array A is generated as follows.

With respect to each of dⱼ⁽ⁱ⁾εΣ,

(1) kⁱ^{_{j,o}}←{0,1}^{l} is generated.

(2) Nodes V_{j,k}ⁱ= [symbol] id(N(d_{j,k}⁽ⁱ⁾))∥k_{j,k}ⁱ∥Ψₓ(ctr+1) [symbol] are generated (where id(N(d_{j,k}⁽ⁱ⁾)) means a k-th identifier of N(dⱼ⁽ⁱ⁾)).

(3) Eₖ_{_{j,k−1}}ⁱ(V_{j,k}ⁱ) is calculated. That is, the nodes V_{j,k}ⁱ are encrypted and then stored in the array A[Ψₓ(ctr)].

(4) The value of the counter increases by 1 (ctr=ctr+1).

(5) The processes (1) to (4) are repeated with respect to all dⱼ⁽ⁱ⁾εΣ, and before encryption is performed on the last node, the address of the next node is stored in NULL.

(6) After the above-mentioned processes are performed for all dⱼ⁽ⁱ⁾εΣ, when m′ is defined as

$${\sum }_{{d}_{j}^{( i )}} \vert N ( {d}_{j}^{( i )} ) \vert$$

$$( that is , {m}^{′} = {\sum }_{{d}_{j}^{( i )}} \vert N ( {d}_{j}^{( i )} ) \vert )$$

and m′<m is satisfied, (m−m′)−number of remaining portions of the arrangement A are filled with random values.

Next, a process of generating a look-up table T in the index generator 200 will be described.

(1) With respect to each of dⱼ⁽ⁱ⁾εΣ,

value=<addr(A(V_{j,1}ⁱ))∥k_{j,0}ⁱ>⊕f_{y}(dⱼ⁽ⁱ⁾), and

T[π_{z}(dⱼ⁽ⁱ⁾)]=value

are set.

(2) If dⱼ⁽ⁱ⁾εΣ is not included in N, the d⁽ⁱ⁾ term of T is filled with a random value.

Finally, an index I=(A,T) is generated, and the index generator outputs the index I.

Next, the trapdoor generator 300 generates T_{d}_{⁽ⁱ⁾}=(π_{z}(d⁽ⁱ⁾), ƒ_{y}(d⁽ⁱ⁾)) with respect to d⁽ⁱ⁾.

Here, ƒ is a pseudorandom function and π and ψ are pseudorandom permutations. The individual functions are defined as follows.

ƒ:{0,1}^{θ}×{0,1}^{p}→{0,1}^{l+log}^{₂}^{m}

π:{0,1}^{θ}×{0,1}^{p}→{0,1}^{p}

Ψ:{0,1}^{θ}×{0,1}^{log}^{₂}^{m}→{0,1}^{log}^{₂}^{m}

Next, the document searching unit performs the following processes.

(1) λ=T[γ] is calculated in (γ,η)=T_{d}_{⁽ⁱ⁾}, and [symbol] α∥k [symbol] =λ⊕η is set.

(2) The encrypted node is decrypted by using the key k at an address value α from the list L.

(3) A document identifier included in the list L is output.

Through the above-mentioned processes, the system 1 for searching encrypted numerical data according to the embodiment of the present invention generates an index for numerical data in a predetermined radix expression and generates a trapdoor for the numerical data, which makes it possible to rapidly and efficiently search for documents including numerical data for search.

Using the system 1 for searching encrypted numerical data, a method of searching for numerical data will be described. In FIG. 1, numerical data for search is input to the document searching unit 400 and the numerical data for search may include a wildcard.

For example, in order to search for documents including a number z, first, the number z is expanded in a number system using a base β. In a case of z=dₙβⁿ+dₙ₋₁βⁿ⁻+ . . . +d₀, the number z can be expressed as (dₙdₙ₋₁ . . . d₀)_{β} in the number system. With respect to each digit dᵢ and the position thereof, the document searching unit 400 searches for N(d₀⁽⁰⁾), N(d₁⁽¹⁾), . . . , N(dₙ⁽ⁿ⁾). The intersection of the document sets output as the search results is obtained and is output as a set of documents including the number z. For example, in order to search for numerical data including a number 10, a document index in which a value in the first position is 0 and a value in the second position is 1 is searched, that is, document sets N(d₀⁽⁰⁾) and N(d₁⁽¹⁾) are searched, and the intersection of the document sets N(d₀⁽⁰⁾) and N(d₁⁽¹⁾) is obtained.

This method can be applied to a wildcard search or a range search.

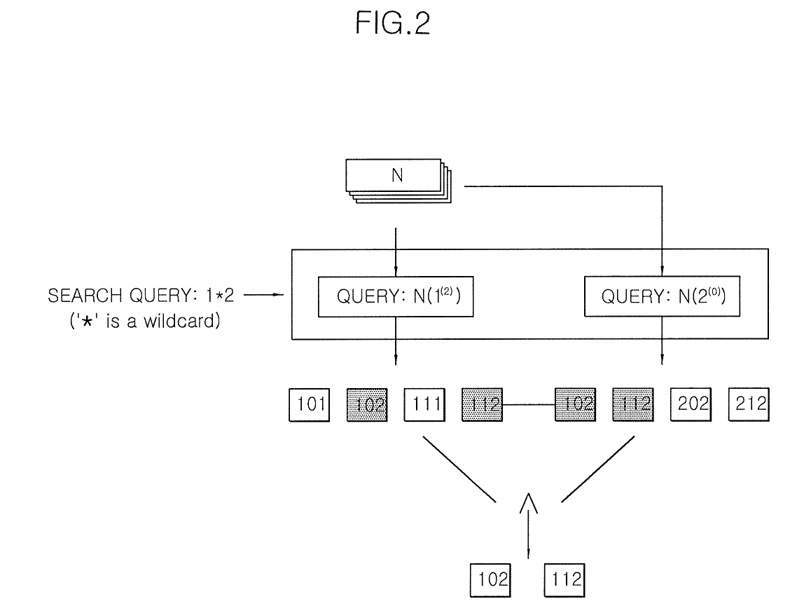

A wildcard search method will be described with reference to FIG. 2. For example, when a user wants to search for a number in which 2 is in the first position and 1 is in the third, a search string including a wildcard may be expressed as “1*2”. If the string is input to the document searching unit, the document searching unit performs searching to obtain document sets N(1⁽²⁾) and N(2⁽⁰⁾). For example, in FIG. 2, a set of documents including “101”, “102”, “111”, and “112” is output as the search result for N(2⁽⁰⁾), and a set of documents including “102”, “112”, “202”, and “212” is output as the search result for N(2⁽⁰⁾). The intersection of the output sets is a set of documents including “102” and “112” and is output. Therefore, a wildcard search is possible.

The above-mentioned method can also be applied to a range search. For example, in order to obtain data on people having the height between 170 cm and 180 cm, a search is performed to obtain document sets N(1⁽²⁾) and N(7⁽¹⁾), and the intersection of the document sets N(1⁽²⁾) and N(7⁽¹⁾) is calculated. Further, in order to obtain data on people having the height between 170 cm and 190 cm, a search is performed to obtain document sets N(1⁽²⁾), N(7⁽¹⁾), and N(8⁽²⁾), the intersection of the document sets N(1⁽²⁾), and N(7⁽¹⁾) is calculated, the intersection of the document sets N(1⁽²⁾) and N(8⁽²⁾) is calculated, and the union of the obtained intersections is obtained, whereby it is possible to obtain desired results. In other words, a wildcard search or a range search can be performed by obtaining the intersection or union of the search results. A search formula for a wildcard search or a range search is not limited to the above-mentioned examples, but can be input in various forms. The system may further include an application searching unit (not shown) that converts a search formula into a form of the union and/or intersection of basic queries by, for example, parsing and then performing an operation.

In a case of generating an index by using various bases, searching of other forms is possible. For example, in order to search for documents containing either odd numbers or even numbers among numerical data, an index may be generated by using 2 as a base so that binary expression is possible. In this way, as described above, it is possible to search for documents containing either odd numbers or even numbers by a simple query search.

According to the system for searching encrypted numerical data according to the embodiment of the present invention, it is possible to perform a wildcard search or a range search in a searching method using a number as a keyword and to efficiently search encrypted data.

As a result, it is possible to solve the security problem of unencrypted database, thereby reducing a risk in database trust, and to improve the efficiency and reliability of numerical data searching. Therefore, the application probability to a database business can increase.

Although specific terms are employed, they are used in a generic and descriptive sense only and not for purposes of limitation.

In the drawings and specification, typical embodiments have been disclosed of the present invention and although specific terms are employed, they are used in a generic and descriptive sense only and not for purposes of limitation. It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents.

What is claimed is:

1. A system for searching encrypted numerical data, the system comprising:
a key generator that generates a key for encryption;
an index generator that generates an index for documents from a plurality of documents including numerical data, on the basis of the generated key, individual digits of the numerical data and the positions of the digits;
a trapdoor generator that generates a trapdoor including search information on the individual digits of the numerical data and the positions of the digits, using the generated key; and
a document searching unit that receives numerical data for search, searches the index using the trapdoor, and outputs document information including the numerical data for search.

2. The system of claim 1,
wherein the numerical data for search includes digits and the positions of the digits, and
the document searching unit searches the index on the basis of the digits and the positions of the digits.

3. The system of claim 1,
wherein the numerical data for search has range search or wildcard search conditions.

4. The system of claim 3,
wherein the document searching unit searches the index on the basis of the individual digits of the numerical data for search and the positions of the individual digits, and combines the search results to perform the range search or the wildcard search.

5. The system of claim 1,
wherein the index generator expresses the numerical data included in the plurality of documents in a notation system of base n (n is a natural number equal to or greater than 2) and generates the index.

6. A method of searching encrypted numerical data, the method comprising:
generating a key for encryption;
generating an index for documents from a plurality of documents including numerical data and on the basis of the generated key, individual digits of the numerical data and the positions of the digits;
generating a trapdoor including search information on the individual digits of the numerical data and the positions of the digits, using the generated key; and
receiving numerical data for search, searching for the index using the trapdoor, and outputting documents including the numerical data for search.

7. The method of claim 6,
wherein the numerical data for search includes digits and the positions of the digits, and
in the searching of the documents, the index is searched on the basis of the digits and the positions of the digits.

8. The method of claim 6,
wherein, when numerical data having range search or wildcard search conditions is input as the numerical data for search, in the searching of the documents, searching is performed on the basis of the individual digits, except for a wildcard, of the numerical data for search and the positions of the individual digits, and the search results are combined to perform a wildcard search or a range search.

9. The method of claim 6,
wherein in the generating of the index, the numerical data included in the plurality of documents is expressed in a notation system of base n (n is a natural number equal to or greater than 2) and the index is generated.
